(19) United States
(12) Patent Application Publication
(10) Pub. No.: US 2018/0168389 A1
(43) Pub. Date: Jun. 21, 2018

(54) BEVERAGE PREPARATION DEVICE AND OPERATING METHOD

(71) Applicant: Eugster / Frismag AG, Amriswil (CH)

(72) Inventors: Daniel Fischer, Romanshorn (CH); Lukas Sonderegger, Heerbrugg (CH)

(73) Assignee: Eugster / Frismag AG, Amriswil (CH)

(21) Appl. No.: 15/127,550

(22) PCT Filed: Feb. 8, 2016
(86) PCT No.: PCT/EP2016/052621

§ 371 Date: Sep. 20, 2016

(30) Foreign Application Priority Data
Apr. 2, 2015 (DE) 10 2015 105 184.2

(51) Int. Cl. A47J 31/44

(52) U.S. Cl. CPC A47J 31/4485

(57) ABSTRACT

A beverage preparation device (1) with a housing (2) and with an apparatus for heating and/or frothing milk, and with a milk pipe (10) through which the apparatus (8) for heating and frothing milk can be supplied with milk. It is provided that the milk pipe (10) is fluid-conductingly connected to docking means (13) which comprise a docking element (16) which can be displaced through a drive unit, particularly an electric motor, between at least one park position (P), a first docking position (27), particularly a milk heating position, spaced from the park position (P), and a second docking position (31), particularly a milk frothing position, spaced from the park position (P) and the first docking position (27), the docking element being fluid-conductingly connected with a supply port (14) for milk in the first (27) and in the second docking connection (31) and uncoupled from it in the park position (P), and in that the docking means (13) are designed as a fluid valve with which a free flow cross-section for milk for regulating a milk flow rate can be varied by displacing the docking element (16) from the first (27) into the second docking position (31).

### BACKGROUND OF THE INVENTION

The invention relates to a beverage preparation device, particularly to a coffee machine with a housing and with an apparatus for heating and frothing milk, and with a milk pipe, preferably designed as a suction pipe, through which the apparatus for heating and/or frothing can be supplied with milk.

The invention further relates to an operating method for such a beverage preparation device.

Beverage preparation devices with milk heating and/or frothing function have long been known. The heating and/or frothing apparatus intended for this use comprises generally a nozzle arrangement (jet pump) which is fluid-conductingly connected to a steam supplying pipe, through which the steam that streams out through a steam nozzle of the nozzle arrangement absorbs milk through a milk pipe (i.e.: suction pipe), which is then heated and/or frothed in a mixing or frothing chamber and delivered to a coffee cup through an outlet opening. An air pipe through which the milk can be supplied with air for the optional frothing process ends generally in the milk pipe. Beverage preparation devices with a milk heating and/or frothing device are described, for example, in publications EP 2 807 964 A1, EP 1 115 317 B1, EP 2 196 118 B1 or DE 20 2011 107 306 U1.

Also known are beverage preparation devices in which a milk container is arranged on a pivotably arranged housing door and is connected to the milk pipe of the milk heating and/or frothing apparatus. It is preferable to connect the milk container itself in the door area with a stationary linking apparatus connected fluid-conductingly with a door-sided supply port with milk, the supply port being connected with the milk pipe of the housing side by closing the door. A connection end turned towards the supply port must hereby be designed and arranged in a manner such that the supply port can be sealingly received at the end of the pivoting motion of the door. As a result, respectively a different configuration of the housing-sided milk pipe end is necessary in hot beverage preparation devices on the market with a left-hinged or alternatively right-hinged door, since, depending on the position of the door hinge, the supply port describes a radius from one or the other direction when the door pivots, and thus a respective direction adapted for one of the hinge positions of the milk pipe connection may not be suitable for the respective alternative door hinge position to ensure a tight connection with the supply port.

### SUMMARY OF THE INVENTION

Based on the aforementioned state of the art, the invention is concerned with the object of specifying an alternative beverage preparation device which ensures a fluid-tight coupling between the milk pipe and the supply port irrespective of the manner of positioning and/or of a possible displacing motion of a supply port for milk. Particularly, the beverage preparation device for the preferred, yet not necessarily implementable case of a door-sided arrangement of the supply port must be alternatively realisable with a right or left door hinge, without necessity of reconfiguring the milk pipe position in the housing of the beverage preparation device. Preferably, the beverage preparation device must be designed in a manner such that, in an operating condition of milk frothing, particularly in conditions of presumed equal convey capability of convey means for milk, a milk flow rate may be transported by the milk pipe being different from a milk flow rate transported in a mere operating condition of milk heating, in which the milk is only heated, yet not frothed. More preferably, the beverage preparation device is configured in a manner such that any contamination of the milk in a fluid-conducting milk reservoir is reliably avoided with a flushing medium or a flushing process of the milk pipe. The object further consists of specifying an optimised operating method for such a beverage preparation device.

Regarding the beverage preparation device, this object is solved with the features disclosed herein, i.e. in a beverage preparation device according to the given type, by the fact that the milk pipe is fluid-conductingly connected with docking means, which comprise a docking element that can be displaced by means of a drive unit, particularly an electric motor, between at least a park position, a first docking position spaced from the park position, particularly a milk heating position, and a second docking position spaced from the park position and the first docking position, particularly a milk frothing position, the docking element that can be displaced being connected both in the first and in the second docking position with a supply port for milk (i.e. it can be connected with the supply port by being displaced from the at least one park position to the first or the second docking position) and uncoupled from this connection in the park position, i.e. it can be uncoupled (fluidly separated) from the supply port by being displaced from the first or the second docking position to the at least one park position, and through the fact that the docking means are designed as a fluid-valve, with which a free flow cross-section for milk can be varied to regulate (vary) a milk flow rate by displacing the docking element from the first to the second docking position.

Regarding the operating method, the object is solved with the features disclosed herein, i.e. by the fact that the docking element is displaced by means of the drive unit, particularly of the electric motor, from the at least one park position to the first or second docking position spaced from it, and thereby coupled (fluid-conducting connected) to the supply port, and by the fact that the docking element is displaced from the first or the second docking position to the at least one park position for uncoupling (i.e. fluidly separating) the milk pipe from the supply port, and by the fact that the free flow cross-section for milk is varied by displacing the docking elements from the first to the second docking position for regulating the milk flow rate conveyed to the heating and frothing apparatus.

Advantageous developments of the invention are specified in the dependent claims. All combinations of at least two of the features indicated in the description, the claims and/or the figures fall within the scope of the invention.

To avoid repetitions, the features disclosed according to the method are to be equally considered as disclosed according to the method and be claimable. Likewise, features disclosed according to the method are to be equally considered as disclosed according to the device and be claimable.

The invention is concerned with the idea of assigning docking means for the milk pipe, preferably designed as a suction pipe, with which the apparatus for heating or frothing milk, preferably having a nozzle arrangement that can be fed with steam, can be supplied with milk, or with the idea of fluid-conductingly connecting the milk pipe with said docking means, the docking means comprising a docking element which can be displaced by means of a drive unit, particularly an electric motor. This docking element can be displaced between at least one park position, particularly spaced from the supply port for milk, and two spaced docking positions (i.e. a first and a second docking position), particularly along a straight-lined or curved displacement path, the docking element being fluid-conductingly connected with the supply port for milk in both docking positions, so that the milk can flow through the supply port in the milk pipe, and through this into the apparatus for heating and frothing milk.

The aforementioned fluid-conducting connection is interrupted in the at least one park position, i.e. the docking element is uncoupled, and particularly spaced, from the supply port.

By designing the docking means simultaneously as fluid-valves, these have the function according to the invention not only of fluid-conductingly connecting and decoupling the milk pipe and thereby the heating and frothing apparatus respectively with and from the supply port and thereby with the milk container, but they also enable to regulate the milk flow rate without necessity of providing an additional throttle-valve by the fact that the free flow cross-section for milk, restricted by the docking means, is different in the first and the second docking position spaced from it. In other words, the docking means have, in addition to the fluid coupling and decoupling function, also a milk-flow throttle function, i.e. they are designed as a fluid throttle valve with which the milk flow rate can be regulated, this being achieved by providing different free flow cross-sections in the first and in the second docking position. In this case, it is preferable that the free flow cross-section for the milk is larger in an operating condition of milk frothing, i.e. in the second docking position, than in the (particularly sole) operating condition of milk heating, i.e. in the first docking position, in order to be able to convey a larger milk flow rate in the operating condition of milk frothing than in the operating condition of milk heating in conditions of presumed equal convey capability of convey means for milk, particularly absorbing means. Preferably, the operating condition of milk frothing and the operating condition of milk heating additionally differ in that air is additionally delivered to the milk in the operating condition of the milk frothing, for example, as described below with reference to an advantageous development of the invention, immediately in the docking means and/or alternatively spaced from them, particularly in the milk pipe and/or a mixing or frothing chamber of the apparatus for heating and frothing milk. Preferably, no air is delivered to the milk in the operating condition of milk heating, in any case at least a lower air flow rate than in the operating condition of the milk frothing.

The beverage preparation device according to the invention enables, in addition to regulating the milk flow rate with the docking element, setting from at least one park position one of the docking positions in which the docking element is coupled with the supply port. Since the docking element is not fluid-conductingly connected with the supply port in the at least one park position, i.e. it is not coupled with it and it is preferably spaced from the supply port, it is ensured that any contamination of the milk in the milk container connected fluid-conductingly with the supply port is reliably avoided during a flushing of the milk pipe with a flushing medium, even in the case that the docking element itself should have a leak—in any case, due to the decoupling and the preferred spacing, there is no possibility for the flushing medium to get out of the docking element, which is in the at least one park position in the beverage preparation device configured according to the invention.

Due to the configuration according to the invention of the beverage preparation device by providing docking means having a position-variable docking element, it is not either essential for ensuring or for producing a sealing connection between the supply port and the milk pipe whether the supply port is arranged permanently fixed in a manner such that the docking element can be coupled with the supply port in its docking position, or if the supply port must be first displaced to this operative position before displacing the docking element, particularly for the case that the supply port is arranged on an optional door of the beverage preparation device and can be displaced to the operative position by closing the door, or in the case that the supply port is permanently coupled with a replaceable milk container and the milk container can be brought to its position on the beverage preparation device by different displacement paths. In the case of the arrangement of the supply port on a door, this door can be realised alternatively with a right or left hinge, without necessity of varying the configuration of the docking means—it must only be ensured that the supply port is always arranged on the same operative position after closing the door, irrespective of the selection of the door hinge. However, due to the provision of the position-variable docking element, it is indifferent on which path the supply port is displaced, particularly pivoted, in this position, since in this case, a coupling position is set for the first time actively from the direction of the milk pipe by means of a drive unit, i.e. the definite coupling does not need to be carried out by the supply port for milk, instead, a coupling or docking is carried out on the part of the machine or of the housing by displacing the docking element to at least one docking position, in other words, towards the supply port. The supply port or a supply port opening is preferably open when the docking element is in the park position.

The displacement path between at least one park position and at least one of the at least two docking positions, and/or the displacement path between the first and the second docking position is preferably of at least 0.5 cm, particularly preferably of 1 cm. The aforementioned displacement path is particularly preferably selected from between 0.5 cm and 5 cm.

It is specially convenient to provide the docking element, at least in sections, being designed from an elastomeric material for ensuring a sealing, fluid-conducting connection, for thus exerting a sealing function immediately on the part of the docking element for connecting the docking element and the supply port. In addition, designing the docking element from an elastomeric material makes it easily possible to open different fluid paths by implementing different positions of the docking element relative to a plunger mentioned below, in which the docking element designed as elastomeric material can sealingly interact with different positions of the plunger.

There are different possibilities of configuring the apparatus for heating and frothing milk—in principle, it is possible to convey the milk through a milk pipe by means of a pump. Likewise, the heating and/or frothing means do not necessarily have to be operated on a steam basis, i.e. mechanically operated frothing means can be realised and/or the heating means can comprise an electric heating element. However, the apparatus for heating and frothing milk preferably comprises a so-called jet pump, which is connected with a steam generating apparatus of the beverage preparation device and by means of which a vacuum is generated when the steam flows through, by which the milk is absorbed through the supply connection from a milk container in a heating and/or frothing chamber by means of both the milk pipe, designed, in this case, as a suction pipe, and the docking element, which is arranged in a docking position of the beverage preparation device, from which chamber the milk heated at this point or, in the case of the air addition, the milk froth, flows out into a drink container, particularly a coffee cup. In principle, it is possible for the device for heating and frothing milk to include two separate, particularly spaced, operative units, namely a heating unit and a frothing unit, particularly for the case that the frothing takes place by mechanical frothing means and the heating takes place electrically or with steam. Alternatively, the heating and the frothing are possibly and preferably, particularly in the cases when the heating and the frothing take place by means of steam using a nozzle or a jet pump, realised in a common unit, i.e. the apparatus for heating and frothing includes a (common) operative unit or is realised as such.

According to the invention, in order to establish a fluid-conducting connection between the supply port, preferably connected and/or detachable connectable with a milk container, and the apparatus for frothing and heating milk, a fluid-conducting connection is established, in which a docking element is actively displaced from a park position, preferably spaced from the supply port, to a park position by means of a drive unit, particularly an electric motor, for example, translationally and/or through a swivel motion, the docking positions being selected in a manner such that, in this motion, the docking element is fluid-conductingly coupled or docked with the supply port for milk.

In order to decouple, i.e. to separate the fluid-conducting connection, the docking element is displaced back to the at least one park position by means of the aforementioned drive unit.

In principle, an embodiment in which the supply port is fixedly positioned relative to the housing of the beverage preparation device, i.e. its position cannot be changed without demounting, is possible and lies within the scope of the invention. However, an alternative embodiment is preferred, in which the supply port is displaceably arranged relative to the docking position, particularly through the fact that the supply port is fixedly positioned on a door which can be displaced, particularly pivoted, relative to the housing, and through the fact that the supply port can be displaced relatively to the at least one docking position by displacing the door. In the case of a fixed arrangement of the supply port on a displaceable door of the beverage preparation device, it is preferable to provide coupling means on the door, through which a milk container of the beverage preparation device can be detachably coupled with the supply port fixed at the door. Alternatively, it is possible to arrange the supply port fixedly on a milk container and thus to position the supply port by positioning the milk container relative to the housing of the beverage preparation device. Alternatively, also a combination is conceivable in a manner such that the supply port is fixedly connected with the milk container and the milk container can be arranged on an optional door of the beverage preparation device, and that the displacement takes place relative to the docking position by displacing, particularly pivoting the optional door.

As mentioned above, an embodiment is particularly preferred, in which the beverage preparation device comprises a door, which can be mounted alternatively in a left-hinged or right-hinged position, the supply port being arranged on the door in a manner such that it remains arranged in the same (operative position) in which the docking element is fluid-conductingly connected with the supply port after the displacement in one of the docking positions when the door is closed, irrespective of whether the door is mounted with a left hinge or right hinge. A free supply port end is hereto preferably arranged in a central position with respect to the door width.

Preferably, the supply port and a displacement path, preferably translational, of the docking element are aligned in this position.

There are different possibilities for implementing the displacement motion of the docking element between the at least one park position and the docking positions, for example, translationally or, alternatively, rotationally or being performed by guide slides, for instance. Thus, it is conceivable to arrange the drive unit, i.e. particularly the electric motor, in a stationary way and to couple the docking element with the drive unit in a manner such that the former is displaced relatively to the drive unit by operating the drive unit. An embodiment is particularly convenient and preferred, in which the docking element is fixedly connected to the drive unit, particularly with a non-rotating portion, particularly with a portion of the housing of the drive unit, and the drive unit in conjunction with the docking element can be yet more preferably translationally displaced during operation of the drive unit relative to or respectively along a stationary guide, particularly fixed to the housing, for example, a gear rack or a spindle.

As will be disclosed below, such a configuration of the drive unit enables particularly a preferred embodiment in which the docking element, in conjunction with the drive unit, can be displaced relative to one stationary plunger, wherein different connection states of the docking means, which is preferably designed as a fluid valve, can be realised by relatively displacing the docking element relative to the plunger.

An embodiment of the beverage preparation device is particularly convenient, in which the docking means are designed regarding their function as fluid valve in a manner such that, at least, a channel (provided additionally to the supply port) can be fluid-conductingly connected to the milk pipe and can be fluidly separated from it by displacing the docking element. In other words, such a channel is fluid-conductingly connected or not to the milk pipe depending on the position of the docking element of the docking means.

As will be disclosed below, such channel consists preferably of a flushing channel for flushing the suction channels in the at least one position of the docking element, i.e. in the position in which the milk pipe is not fluid-conductingly connected with the supply port.

As indicated before, it is particularly convenient for the docking element to admit its displacement relative to a stationary plunger. For this purpose, the docking element is designed as a docking sleeve in which the plunger is received. Different positions of the docking means designed as a fluid valve can be regulated through, particularly, translational relative displacement of the docking element relative to the plunger, wherein the docking element interacts hereto sealingly with the plunger in the different positions at different points in order to open and/or restrict discrete or different fluid paths and/or different flow cross-sections for milk. In other words, the sleeve-type docking element in conjunction with the plunger restricts different fluid paths and/or flow cross-sections for milk in the different relative positions, the sleeve sealingly interacting hereto with the plunger in different positions along its longitudinal extension. The aforementioned different fluid paths and/or flow cross-sections are realised as grooves or groove portions in the outer area of the plunger and/or in the inner area of the sleeve.

An embodiment of the beverage preparation device is particularly preferred, in which the aforementioned plunger in the at least one park position locks one inlet opening (docking opening), particularly frontal, of the docking element. In other words, active movable lock elements provided additionally to the docking element to lock the aforementioned inlet opening may be dispensed with, and the inlet opening can be locked by actively displacing the docking element relative to the plunger in a manner such that the plunger at least protrudes into the inlet opening or goes through it, preferably axially. Thus, it is also ensured that most of the surfaces contaminated with milk are flushed in a preferred flushing position disclosed below, in which the flushing channel is fluid-conductingly connected with the milk pipe.

There are different possibilities for realising the different free flow cross-sections for the milk in both docking positions in which the docking element is fluid-conductingly connected with the supply port. Thus, it is possible and preferable to provide at least an open groove, preferably extending in the direction of the longitudinal extension of the docking element, on the outer area of the aforementioned plunger and/or on the inner area of the, preferably, sleeve-type docking element, so that the milk flows through said groove in the direction of the milk pipe, the respective other part (docking element or plunger) sealingly interacting particularly in radial direction with the groove edge, different groove cross-sections interacting with the respective other component in the different docking positions, so that different milk flow rates can be conveyed in the first and in the second docking position. It is also conceivable to realise at least a channel provided in the inside of the plunger or of the docking element in addition to or instead of the aforementioned groove, said channel allowing the milk to flow through in one of the docking positions and not in the other, or said channel having inflow and outflow cross-sections (flow cross-sections) of different sizes in the different docking positions.

It has proved to be particularly advantageous to provide an aforementioned groove, in this case open radially outwards, particularly elongated, in the plunger, this groove or groove portion preferably fluid-conductingly communicating with a widened and/or deeper groove portion or a widened and/or deeper gap providing a larger flow cross-section, the docking element sealingly interacting with the (narrower and/or less deep) groove or groove edges in one of the docking positions and with the edge of the wider and/or deeper nut portion or gap in the other docking position.

Obviously, it is also possible to provide the aforementioned groove open radially inwards on the inner area of the docking element, as well as the gap, in this case the plunger sealingly interacting either with the narrower groove or the groove edge, or with the gap edge depending on the docking position. It is also possible to distribute the different groove or gap portions on the plunger and the docking element.

As indicated above, the channel fluid-conductingly connected with the milk pipe in the park position can be designed as a flushing medium ending in the docking means, admitting its supplying with flushing medium. The flushing medium can be water and/or steam. The aforementioned flushing channel is fluidly separated from the milk pipe by positioning the docking element relative to the plunger in the at least one docking position in order to avoid any contamination of the milk with flushing medium.

In principle, in the case that milk froth is produced with the beverage preparation device, it is possible to deliver air into the milk on one of the different positions of the docking means, for example, immediately into the milk pipe and/or into one of the aforementioned milk or frothing chamber, respectively. An embodiment is particularly convenient, in which an air pipe ends in the docking means, the air pipe being able to be opened and closed by displacing the docking element between the two different spaced docking positions. In other words, the air pipe is open due to the positioning of the docking element in the milk frothing position (second docking position), i.e. it is fluid-conductingly or air-conductingly connected with the milk pipe, and it is locked or at least less wide open in the milk heating position (first docking position) than in the milk frothing position.

Regarding the realisation of the docking positions spaced from each other, it is advantageous that the coverage degree between the docking element and the supply port is different in the milk frothing position and in the milk heating position.

### BRIEF DESCRIPTION OF THE DRAWINGS

Further advantages, features and details of the invention result from the following description of preferred embodiments and from the drawings.

In the figures:

FIG. 1 shows a part of a beverage preparation device designed according to the idea of the invention,

FIG. 2 shows docking means of the beverage preparation device according to FIG. 1, with a docking element in a park position,

FIG. 3 shows the docking means according to FIG. 2, the docking element being arranged in this case in a first docking position (milk heating position),

FIG. 4 shows the docking means according to FIGS. 2 and 3, with a second docking position (milk frothing position) spaced from the first docking position,

FIG. 5 shows an alternative exemplary embodiment of the docking means, which also ends in the air pipe which is fluid-conductingly decoupled from a milk pipe in a first docking position (milk heating position) shown in FIG. 5, and

FIG. 6 shows the docking means according to FIG. 5, in a second docking position, axially spaced from the first docking position, with an air pipe which is air-conductingly connected with the milk pipe.

In the figures, the same elements and elements with the same function are indicated with the same reference numbers.

### BRIEF DESCRIPTION OF THE DRAWINGS

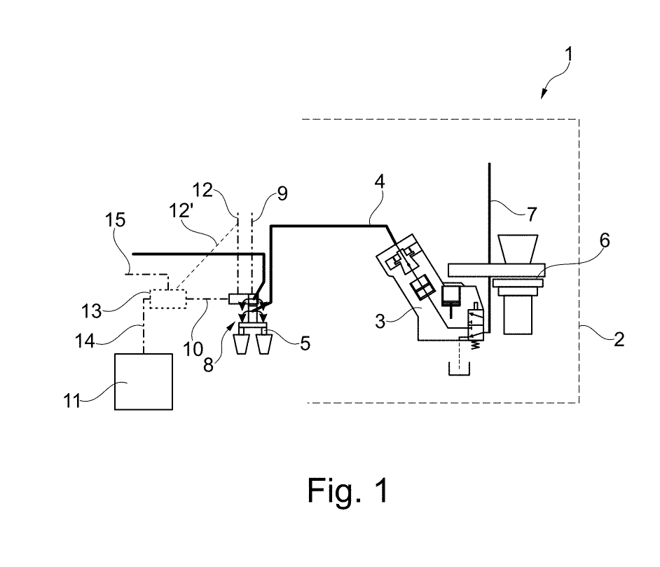

FIG. 1 represents partially a beverage preparation device 1 designed only by way of example as a coffeemaker. As an alternative to the coffeemaker, the beverage preparation device can also be designed as a portion unit machine, particularly as a coffee capsule machine. Likewise, it does not necessary have to be a coffee machine—only the function of heating and/or frothing milk must be present.

The beverage preparation device 1 comprises a housing 2.

A brewing unit 3 for making coffee is present in the housing 2, the coffee admitting being supplied to an outlet 5 through a beverage pipe 4. In the concrete exemplary embodiment, the coffee is brewed on a ground coffee basis, which can be produced with an integral coffee grinder 6. In the case of an alternative configuration as portion unit machine, the ground coffee is supplied by means of a portion unit, particularly a capsule.

As can also be seen in FIG. 1, a hot water pipe 7 through which hot water is supplied to the brewing unit 3 ends in the brewing unit 3, the water being heated in a known manner in a flow-type heater not shown.

It can also be seen that the beverage preparation device 1 includes an apparatus 8 for heating and frothing milk. This known apparatus 8, not shown in detail, comprises a nozzle arrangement with a jet nozzle or jet pump, which can be provided with steam from a steam pipe 9 for producing vacuum and for heating and/or frothing milk. Depending on the configuration of the beverage preparation device, the steam can be produced in the same flow-type heater as the hot water for supplying the brewing unit 3. It is also conceivable to provide an additional steam generator. The apparatus 8 is supplied with milk through a milk pipe 10, through which milk can be absorbed from a removable milk container 11 of the beverage preparation device 1 or beverage preparation device system through the aforementioned vacuum.

According to a first exemplary embodiment, air can be supplied through an air pipe 12 into the milk pipe 10, in this case by way of example in the area of the apparatus 8. An alternative air pipe routing 12′ is shown in dashed lines. In this case, the air pipe 12′ ends immediately in docking means 13 described below and can be opened or blocked with these in an advantageous configuration of the invention.

A fluid-conducting connection can be established with a supply port 14, particularly a door-sided supply port or a supply port on the side of the milk container, by means of the docking means 13, which are fluid-conductingly connected with the milk pipe 10, by displacing a docking element, not shown, of the docking means 13 between a park position and one of at least two docking positions by means of a, particularly, electromotive drive unit.

A channel 15 designed in this case as flushing channel ends in the docking means 13, through which the docking means can be flushed with flushing medium, particularly hot water and/or steam, in a park position of the aforementioned docking element, the channel 15 being uncoupled from the milk pipe 10 in the aforementioned docking positions conditioned by the relative position of the docking element with which it is fluid-conductingly connected in the park position.

Alternatively to the design of the flushing channel as active feed channel for supplying flushing medium to the docking means, the channel can also serve as disposal channel for diverting the flushing medium out of the docking means in an alternative case, when the docking means are flushed through the milk pipe—in this case, the feeding of flushing medium preferably takes place in an area between the docking means and the apparatus for heating and frothing milk, for example through an air channel or a separate flushing channel.

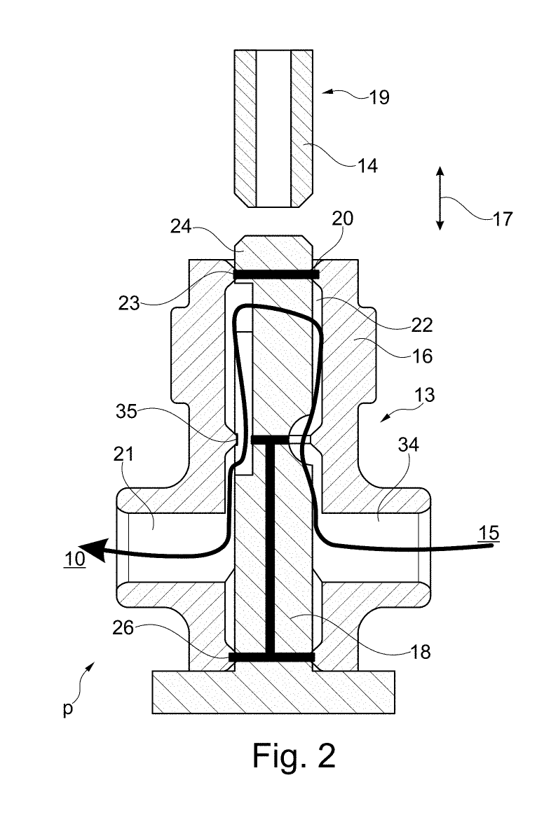

FIG. 2 shows a possible variant of a configuration of the docking means 13. These comprise, as mentioned before, a docking element 16 designed here by way of example from an elastomeric material, the docking element being displaceable—in the concrete exemplary embodiment merely translationally along an axial displacement axis 16—through a, particularly, electromotive drive unit, not shown. The docking element 16 is hereto fixedly connected with the unit and can be displaced in conjunction with the drive unit relative to a routing which is not shown. This routing is stationarily arranged, such as a plunger 18 described below, which is present at least in sections in the inner part of the sleeve-type docking element 16 and restricts different fluid paths in conjunction with this conditioned by the relative position between the docking element 16 and the plunger 18.

It is essential that the position of the docking element 16 can be varied relative to the supply port 14, which is, by way of example, fixedly arranged on a milk container or on an optional door, particularly pivotably arranged. In order to establish a coupling with this supply port 14, this must be in the shown operative position 19. Depending on the configuration of the beverage preparation device 1, the supply port, in this case, not displaceable, remains permanently in this operative position. It is particularly preferred that the supply port 14 must be initially displaced into this operative position, particularly by pivoting the mentioned door.

FIG. 2 shows an operating condition or valve positioning of docking means 13 designed as a fluid valve, wherein the docking element 16 is axially spaced from the supply port 14 and is not fluid-conductingly connected therewith. A frontal inlet opening 20 of the docking means 13 is locked by means of the plunger 18 by its protruding into the inlet opening 20.

A channel 15 designed in this case as flushing channel is fluid-conducting connected with a milk connection 21 (docking element outlet) of the docking means 13 and thereby with the milk pipe 10 in the represented park position P. The channel 15 is connected with a channel connection 34 of the docking means 13, more precisely, of the docking element 16. However, if flushing medium is supplied through the channel 15, this reaches a valve chamber 22 restricted by the plunger 18 and the docking element 16 and flows through this into the milk pipe 10. As an alternative, a reverse fluid flow can be realised.

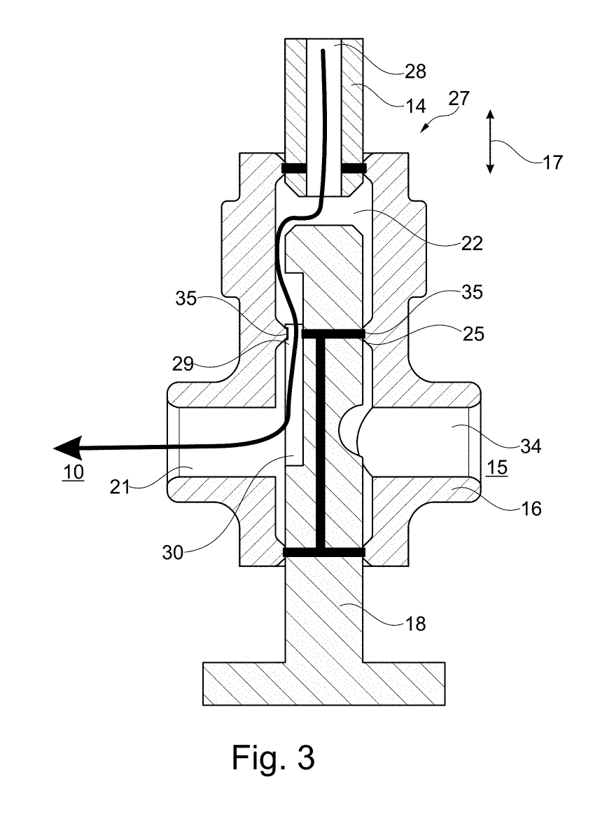

It can be seen that the docking element has different seal sections, namely a frontal seal section 23 which restricts the inlet opening 20 and interacts sealingly in the park position with a frontal cylinder section 24 of the plunger. A middle seal section 35 is further provided, with which the channel 15 can be fluidly separated from the milk pipe 10 by interacting with an opposite section 25 of the plunger (18) (see FIG. 3).

Additionally, the docking means 13 also comprise a rear seal section 26 for sealing the valve chamber 22 downwards or backwards in the drawing layer. In an alternative embodiment which will be described below, an optional air pipe can still be opened or blocked with the rear seal section (26) or other seal section.

FIG. 3 it can be seen that, in comparison with FIG. 2, the docking element 16 has been translationally displaced along the displacement axis 16 forwards in the direction of the supply port 14. The docking element 16 is in a first docking position 27 of a total of two docking positions. The supply port 14 protrudes into the docking element 16 in the first docking position 27, so that the milk feed line 28 of the docking element ends into the valve chamber 22. At the same time, the middle seal section 24 interacts with the plunger 18 in a manner such that the channel 15 is decoupled from the milk pipe 10 or the milk connection 21 designed as suction connection (docking element outlet). A fluid-conducting connection is present between the supply port 14 and the milk pipe 10. The milk can flow radially in axial direction between the plunger 18 and the inner area of the docking element 16 to the milk pipe 10. In this way, the free flow cross-section for the milk is narrowed, since the milk must flow through a narrowed groove section 29 of a groove provided in the outer area of the plunger 18. Thereto, the middle seal means 24 restrict the aforementioned reduced cross-section with the narrowed groove section 29 of the groove 30. Obviously, such narrowed groove can be also alternatively provided in the inner area of the docking element 16, the plunger 18 in this case also restricting the reduced free milk flow cross-section with this narrowed groove cross-section.

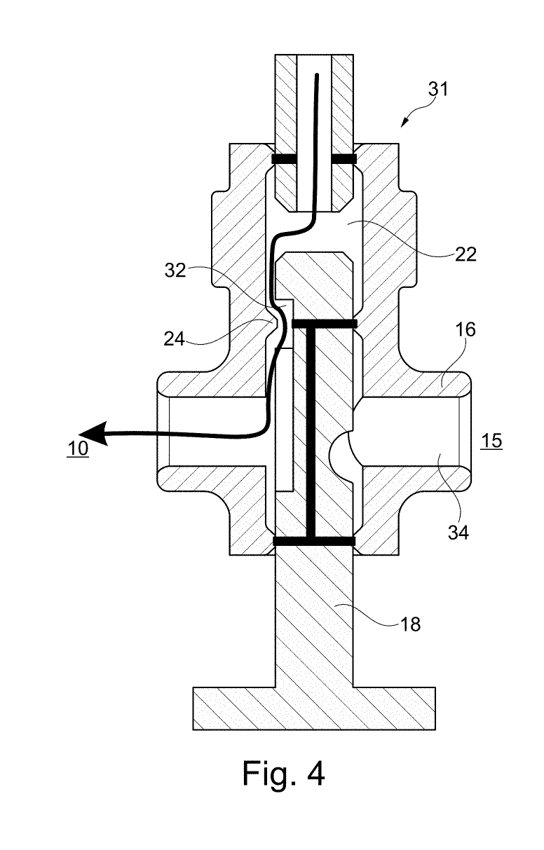

In FIG. 4, the docking element 16 is further moved forward and is in a second docking position 31. Obviously, the channel 15 is still decoupled from the milk pipe 10 in this position. The essential difference is that the middle seal section 24 interacts now with a widened groove section 32 of the plunger 18, so that a widened or larger free milk flow cross-section is open and therefore more milk per time unit is absorbed assuming same suction pressure. This is desirable for producing milk froth. In the exemplary embodiment shown, the milk pipe 10 is supplied with air in a known way in other position in order to generate milk froth in the milk chamber of the apparatus 8 (see FIG. 1).

It can be seen that the coverage degree between the docking element 16 and the supply port 14 is different in the different docking positions 27, 31—specifically, the axial coverage in this case is higher in the second docking position 31.

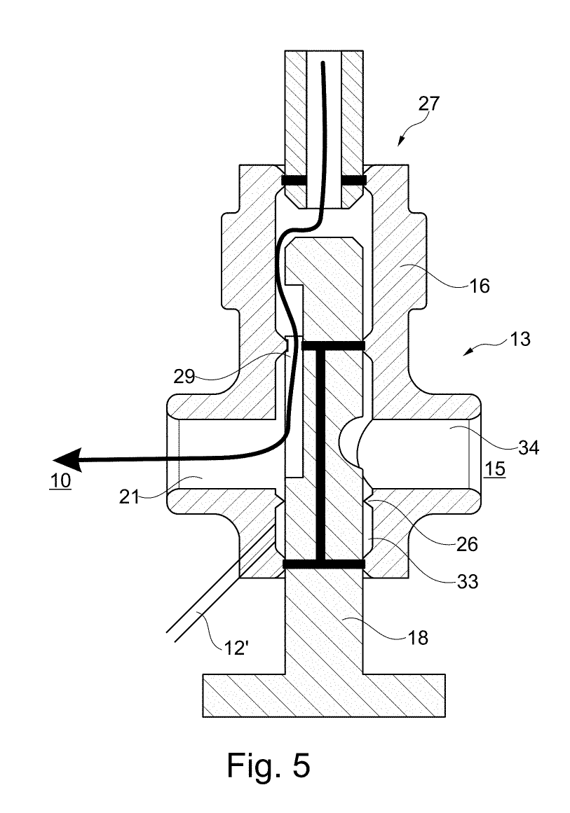

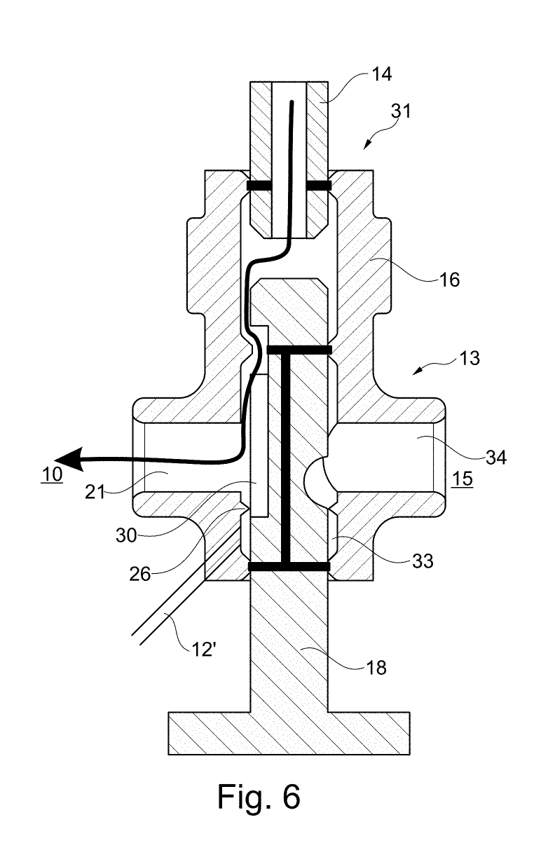

FIG. 5 and FIG. 6 show an alternative embodiment of the docking means 13, wherein, in order to avoid repetitions, essentially the differences with respect to the embodiment described below will be addressed. Regarding the similarities, reference is made to FIGS. 2 to 4 with corresponding description of the figures.

FIG. 5 shows the docking element 16 in the first docking position 27, in which the milk must flow through the narrowed groove cross-section 29 of the plunger 18. The channel 15 is not fluid-conductingly connected to the milk pipe 10.

Unlike the embodiment described above, an air pipe 12′ ends in this case in the docking means 13, more specifically in the docking element 16, in a rear valve space 33 restricted by the plunger 18 and the docking element 16. The rear seal section 26 of the docking element 13 seals the rear valve chamber opposite to the milk pipe 10. The milk is only heated, not frothed.

In FIG. 6, the docking element 16 is again in its second docking position 31. In this case, the rear valve chamber 33 is air-conducting connected with the milk pipe 10 through the groove 30, so that not only milk can be absorbed through the supply port 14, but also air through the air pipe 12′. It can be seen that the relative position between the docking element 16 and the plunger 18 accounts again for the opening of the air pipe 12′. The rear seal section 26 is now immediately radially adjacent to the groove 30.

Obviously, alternative arrangements of the air pipe and of the seal sections are also possible. There may also be different numbers of seal sections provided in order to implement more or less functionalities.

1. Beverage preparation device (1) with a housing (2) and with an apparatus for heating and/or frothing milk and with a milk pipe (10) through which the apparatus (8) for heating and frothing milk can be supplied with milk, wherein
the milk pipe (10) is fluid-conductingly connected with docking means (13) which comprise a docking element (16) which can be displaced through a drive unit between at least a park position (P), a first docking position (27) spaced from the park position (P), and a second docking position (31) spaced from the park position (P) and the first docking position (27), the docking element being fluid-conductingly connected with a supply port (14) for milk in the first (27) and in the second docking connection (31) and uncoupled from it in the park position (P), and wherein the docking means (13) are designed as a fluid valve with which a free flow cross-section for milk for regulating a milk flow rate can be varied by displacing the docking element (16) from the first (27) into the second docking position (31).

2. Beverage preparation device according to claim 1, wherein the supply port (14) is displaceably arranged relative to the docking position (27, 31).

3. Beverage preparation device according to claim 2, wherein the supply port (14) is arranged on a door of the beverage preparation device (1) that can be displaced relative to the housing (2), and/or on a removable milk reservoir of the beverage preparation device (1).

4. Beverage preparation device according to claim 3, wherein the supply port (14) is arranged on the door in such a way that, irrespective of a left-hinged or right-hinged mounting of the door, it is arranged when the door is closed in a way such that the docking element (16) is fluid-conductingly connected with the supply port (14) in its docking position (27, 31).

5. Beverage preparation device according to claim 1, wherein the docking element (16) is fixedly connected with the drive unit and can be displaced for displacing between the at least one park position (P) and the docking positions (27, 31) in conjunction with the drive unit along a stationary routing.

6. Beverage preparation device according to claim 1, wherein the docking element (16) is designed as a docking sleeve in which a plunger (18) is received and wherein the free flow cross-section for the milk can be modified through relative displacement of the docking element (16) relative to the plunger (18).

7. Beverage preparation device according to claim 6, wherein the plunger (18) is interactingly designed and arranged with the docking element (16) in a way such that an inlet opening of the docking element (16) of the plunger (18) can be locked by displacing the docking element (16) to the at least one park position (P).

8. Beverage preparation device according to claim 6, wherein the variable free flow cross-section is restricted by the docking sleeve and the plunger (18) in a way such that a smaller free flow cross-section is restricted by a groove (30), in the plunger (18) or in the docking sleeve and a larger free flow cross-section is restricted by a widened and/or deeper section of the groove (30) or a gap adjacent to the groove (30) in the plunger (18) or the docking sleeve, and wherein a relative displacement of one seal section restricting the free flow cross-section can be implemented relative to the groove (30) and/or the gap by displacing the docking sleeve.

9. Beverage preparation device according to claim 1, wherein the fluid valve is designed in a way such that at least one channel (15) can be fluid-conductingly connected to the milk pipe (10) and fluidly separated by displacing the docking element (16).

10. Beverage preparation device according to claim 9, wherein the fluid valve is configured in a way such that a supply port ending in the docking means (13) designed as flushing channel, is fluid-conductingly connected to the milk pipe (10) in the park position (P) and fluidly separable from the milk pipe (10) in the docking position (27, 31) by displacement of the docking element (16).

11. Beverage preparation device according to claim 9, wherein the fluid valve is configured in a way such that an air pipe (12′) ending in the docking means (13) is open in the second docking position (31) and thus is able to introduce air into an absorbed milk flow, and wherein the air connection can be closed by displacing the docking element (16) into the first docking position (27) or at least a free cross-section for air can be narrowed.

12. Beverage preparation device according to claim 1, wherein a coverage degree between the docking element (16) and the supply port (14) is different in the first (27) and the second docking position (31).

13. Method for operating a beverage preparation device (1) according to claim 1, wherein the docking element (16) is displaced from the at least one park position (P) to the first (27) or second docking position (31) spaced from it by means of the drive unit for fluid-conductingly connecting the milk pipe (10) to the supply port (14) for milk and thereby coupled to the supply port (14), and wherein the docking element (16) is displaced from the first (27) or the second docking position (31) to the at least one park position (P) for fluidly separating the milk pipe (10) from the supply port (14), and wherein the free flow cross-section for milk is varied by displacement of the docking elements (16) from the first (27) to the second docking position (31) for regulating the milk flow rate transported to the heating and frothing apparatus.

14. Method according to claim 13, wherein, before displacing the docking element (16) from at least one park position (P) to the first at least one docking position (27), the supply port (14) is displaced to an operative position by closing a door having the supply port (14), in which the docking element (16) can be docked and/or is docked to the supply port (14) in its docking position (27, 31).

15. Beverage preparation device according to claim 1, wherein the drive unit is an electric motor.

16. Beverage preparation device according to claim 1, wherein the first docking position is a milk heating position and the second docking position is a milk frothing position.

17. Beverage preparation device according to claim 3, wherein the housing has the docking means (13) for a milk reservoir.

18. Beverage preparation device according to claim 5, wherein the docking element (16) can be translationally displaced between the at least one park position (P) and the docking positions (27, 31), and wherein the stationary routing is a gear rack or a spindle.

19. Beverage preparation device according to claim 6, wherein the plunger (18) is stationarily arranged, and wherein the free flow cross-section for the milk can be modified through relative translation of the docking element (16) relative to the plunger (18).

20. Beverage preparation device according to claim 10, wherein the supply port ending in the docking means (13) is supplied with water and/or steam.
